(19) United States
(12) Patent Application Publication
(10) Pub. No.: US 2007/0101523 A1
(43) Pub. Date: May 10, 2007

(54) Drain clearing cable guide

(76) Inventor: David Alan Thompson, Stanton, CA (US)

Correspondence Address: David Alan Thompson, 8440 Cerritos ave. unit J, Stanton, CA, 90680, US

(21) Appl. No.: 11/269,084

(22) Filed: Nov. 8, 2005

(51) Int. Cl. B08B 9/043

(52) U.S. Cl. 15/104.33

(57) ABSTRACT

The invention is a portable drain clearing cable or snake guide device. It is designed to assist anyone wanting to clear a drain blockage or stoppage in a back to back plumbing fixture drain tee fitting via an electric or manually operated rooter cable or snake and guiding this cable or snake in a downward fashion towards the blockage or stoppage. It is designed to help clear a drain blockage or stoppage in a back to back plumbing drain fixture tee better, faster and with less of a chance for the cable or snake to cause damage to the opposing plumbing at the other side of drain fixture tee.

### BACKGROUND OF THE INVENTION

1. Field of the Invention

The present invention introduces a device for use by anyone wanting to clear a drain that is of the back to back design whereas with this back to back fitting or tee the cable or snake is apt to move in an unwanted direction due to the inherent design of this fitting. This invention introduces a tool that is introduced into the above described fitting that guides the cable or “snake” into a direction that is more apt to clear drain line.

2. Description of Related Art

A search of prior art did not disclose any patents that read directly on the claims of this instant invention.

### BRIEF SUMMARY OF THE INVENTION

The invention is used to aid anyone wanting to clear a back to back plumbing fixture tee stoppage, via an electric or manual drain clearing cable or snake. It has aspects of a straight tubular piece of pipe and a curved tubular piece of pipe within it and the necessary hardware to attach the invention to said plumbing fixture tee.

### BRIEF DESCRIPTION OF DRAWINGS

The invention will now be described, by way of example only, with reference to the accompanying drawings, as follows.

FIG. 1. Perspective side view of a preferred embodiment of the present invention.

FIG. 2. Perspective back view of a preferred embodiment of the present invention.

FIG. 3. Perspective frontal view of a preferred embodiment of the present invention.

FIG. 4. Perspective cut away view of a preferred embodiment of the present invention.

### DESCRIPTION OF THE INVENTION

Detailed descriptions of the preferred embodiments of the present invention are provided herein. It is to be understood, however, that the present invention may be embodied in various forms. therefore, specific details disclosed herein are not to be interpreted as limiting, but rather as a basis for the claims and as a representative basis for teaching one skilled in the art to manufacture and employ the present invention in virtually any appropriately detailed system, structure or manner.

### DETAILED DESCRIPTION OF THE INVENTION

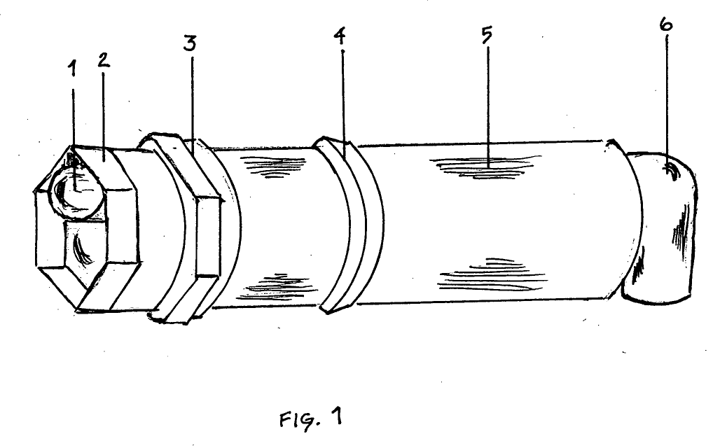

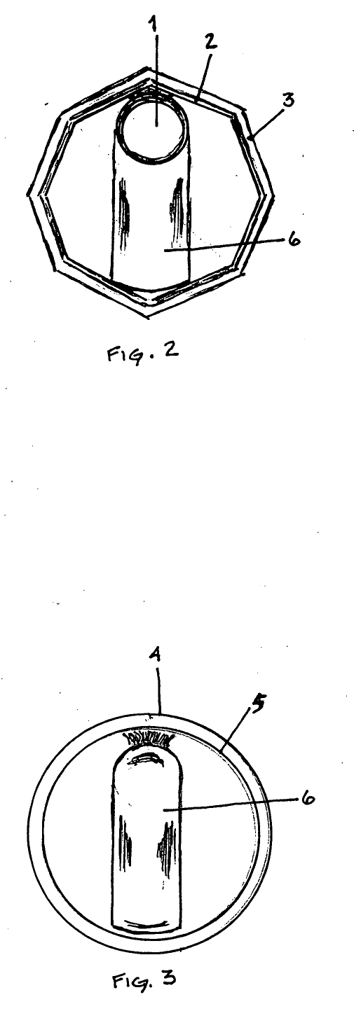

The present invention is a portable device, a tool designed to aid anyone wanting to clear a blockage in a back to back plumbing fixture fitting. These plumbing fixture fittings are of a tee arrangement and have an inherent design that when a cable or snake is introduced into one side of the tee fitting, it is apt to travel to the path of least resistance, the other side of the tee fitting rather than in a downward direction where the stoppage is. The present invention corrects this problem. The drawing of FIG. 1. represents a side view of the present invention which can be made of many types of metal and even the right type of plastic. Demonstrated in FIG. 1. is an opening that allows for the introduction of a cable or snake (1). It has a hex shape at one end that aids the user in the insertion of the device into and out of a plumbing drain nipple (2). It has a standard within the industry slip nut and washer (3) and (4) that fastens the tool to above forementioned drain nipple. The outer body of the device is of tubular design (5). The inner tube (1) is curved downward on one end (6). The drawing of FIG. 2. represents a back side view of the device.

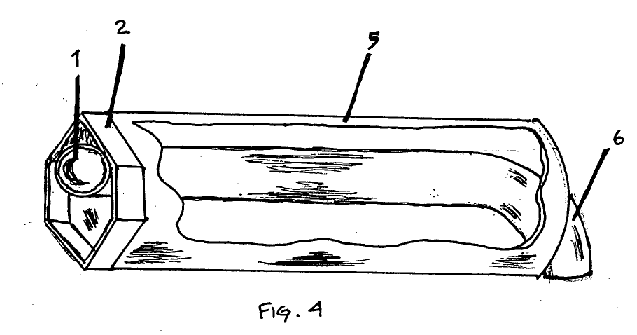

The Drawing of FIG. 3. represents a frontal view of the device. The drawing of FIG. 4. represents a cut away view of the device and shows the inner hollow tube guide for the drain clearing cable or snake (1) and (6).

While the present invention has been described in terms of several preferred embodiments, this is not intended to limit the invention to the particular forms set forth, on the contrary, the present invention is intended to cover such alternatives, alterations, modifications and equivalent structures and devices as may be included within the spirit and scope of the invention as defined within the appended claims.

I claim:

1. A portable drain clearing cable guide, comprising:
a tubular circular main body;
a hex shaped area at one end of said main body;
an inner circular and curved tube.

2. The portable drain clearing cable guide I further comprising
a round tubular circular main body.

3. The portable drain clearing cable guide device of claim I further has a six sided hex shaped area at one end of main body.

4. The portable drain clearing cable guide device of claim I further has openings at either end of said main body.

5. The portable drain clearing cable guide device of claim I further has an inner circular curved tube attached to main body.

6. The portable drain clearing cable guide device of claim I further has openings at either end of said inner tube.
